(19) United States
(12) Patent Application Publication
(10) Pub. No.: US 2010/0122596 A1
(43) Pub. Date: May 20, 2010

(54) Ball Screw

(76) Inventor: Ming-Yao LIN, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/340,734

(22) Filed: Dec. 21, 2008

(30) Foreign Application Priority Data
Nov. 14, 2008 (TW) 097144113

(51) Int. Cl. F16H 25/22

(52) U.S. Cl. 74/424.83

(57) ABSTRACT

A ball screw comprises a screw, a nut, two return assemblies and a rolling assembly. The two return assemblies are disposed in two ends of the nut, and each of the return assemblies is defined with a return passage provided with two guiding grooves at two sides thereof for guiding the linking portions of the rolling assembly. The guiding grooves twist an angle of about 90 degrees within the return portion of each of the return assemblies to prevent the linking portions from being stretched or extruded improperly to reduce the deformation to the lowest, thus effectively extending the service life of the rolling assembly.

### BACKGROUND OF THE INVENTION

1. Field of the Invention

The present invention relates to a ball screw applied for linear transmission, and more particularly to a ball screw, which can effectively extend the service life of the rolling assembly.

2. Description of the Prior Art

As for precision machineries, in order to control the feed rate precisely and with low friction coefficient, ball screws are used for precision transmission. Such a ball screw is normally provided with a screw, a nut and plural balls between the screw and the nut. The balls roll circularly within the nut through return assemblies provided on the nut. Referring to FIG. 9, a nut 51 is moveably mounted on a screw 50 and provided with a return assembly 52 at each of two opposite ends thereof. The screw 50, the nut 51 and the return assemblies 52 define a circulation path 54 for endless circulation of a rolling assembly 55. In order to avoid undesired rotation of the rolling assembly 55, the circulation path 54 is defined with guiding grooves 541. The rolling assembly 55 is provided with two linking portions 551 at two opposite sides thereof for linking plural rolling elements 550 together. The linking portions 551 slide along the guiding grooves 541 of the circulation path 54, and the guiding grooves 541 at the two sides of the respective return assemblies 52 are disposed along the arcs defined by the smallest radius and the biggest radius of a return portion 520, so that when the rolling assembly 55 passes through the return portion 520, the linking portions 551 at the two sides of the rolling assembly 55 will slide along the guiding grooves at the two sides of the return assembly 52 and bend therein, the direction in which the linking portions 551 bend is obviously vertical to the bendable direction of the linking portions 551, thus causing serious damage to the linking portions 551.

After entering one of the return assemblies 52, the linking portions 551 will move along the guiding grooves 541 at the two sides of the one of the return assemblies 52 and pass through the right-angled return portion 520 of the one of the return assemblies 52 and then pass through the right-angled return portion 520 of the other of the return assemblies 52 and finally return between the screw 50 and the nut 51. When passing the right-angled return portion 520, the linking portions 551 at the two sides of the rolling assembly 50 are located within the arcs defined by the smallest radius and biggest radius of the return portion 520, namely one of the linking portions 551 is located within the arc defined by the biggest radius of the return portion 520 and subject to an improper stretching force, and the other of the linking portions 551 is located within the arc defined by the smallest radius of the return portion 520 and subject to an improper extrusion force. Due to the design of the linking portions 551 of the rolling assembly 55, the bendable direction of the rolling assembly 55 is located at a side where no linking portions 551 are disposed. The direction in which the guiding grooves 541 at the two sides of each of the return assemblies 52 guide the linking portions to bend is located on the linking portions at the two sides of the rolling assembly 55, so that when passing the respective return portions 520, one of the linking portions 551 will be improperly stretched, and meanwhile the other of the linking portions 551 will be extruded. As a result, the linking portions 551 of the rolling assembly 55 are more likely to rupture due to being improperly stretched or extruded.

When the linking portions 551 at the two sides of the rolling assembly 55 are improperly stretched and extruded synchronously within the return portion 520, they slide at very high speed, and the rolling elements 550 which change the moving direction quickly when entering the return portion 520 are likely to collide with the inner surface of the return assembly 52 to cause vibration. Therefore, when passing the return portion 520, the rolling assembly 55 will be affected by the vibration of the rolling elements 550 or the pulling force between the rolling elements 550, in addition, the rolling assembly 50 is more likely to rupture immediately since the linking portions 551 at the two sides of the rolling assembly 55 are improperly or excessively stretched or extruded. Moreover, since the linking portions 551 at the two sides of the rolling assembly 55 are stretched or extruded synchronously, the rolling elements 550 will deviate from its original path, thus causing undesired friction which will make the circulation of the rolling assembly unsmooth. Additionally, the improper collision will cause noise.

The present invention has arisen to mitigate and/or obviate the afore-described disadvantages.

### SUMMARY OF THE INVENTION

The technical problems to be solved:

When the rolling assembly which rolls within the conventional ball screw passes through the right-angled return portion of the return assembly, the linking portions of the rolling assembly will slide along the arc routes defined by the smallest radius and the biggest radius of the return portion, so that the rolling assembly is likely to rupture due to the excessive deformation of the linking portions within the return portion, and the improper deformation of the linking portions will greatly increase the friction between the rolling assembly and the return assemblies to cause the unsmooth circulation of the rolling assembly and noise.

In order to solve the above technical problems, the present invention provides a ball screw. The ball screw in accordance with the present invention comprises a screw, a nut, two return assemblies and a rolling assembly. The screw is provided with a screw helical rolling groove and a screw thread, and the nut is provided with a nut helical rolling groove opposite the screw helical rolling groove and a nut thread opposite to the screw thread. The screw rolling groove cooperates with the nut rolling groove to define a loaded path, and a guiding space is defined between the screw thread and the nut thread. The nut is provided with a receiving groove in each of two opposite ends thereof for accommodation of the return assemblies. Each of the return assemblies is provided with a linking portion, a return portion and a connecting portion in order and further defined with a linking portion passage, a return portion passage and a connecting portion passage in the linking portion, the return portion and the connecting portion, respectively, wherein the linking portion passage is linked up with the loaded path, and both ends of the return portion passage are connected to the linking portion passage and the connecting portion passage, thus defining a return passage, the other end of the connecting portion passage is connected to the other return assembly through the rolling passage, each of the linking portion passage, the return portion passage and the connecting portion passage is defined with two guiding grooves in the return passage, one end of the two guiding grooves of the linking portion passage is linked up with the guiding space and has a first angular difference with respect to the other end of the two guiding grooves of the linking portion passage. The rolling assembly includes a chain having plural rolling elements. The chain includes two linking portions at two sides thereof. The linking portions of the chain slide within the guiding space between the screw and the nut and the guiding grooves of the return passage, when the rolling assembly moves from the guiding space to the return portion passage, the linking portions of the chain will be guided by the guiding grooves of the linking portion passage to move and twist an angle of the first angular difference of about 90 degrees.

There is a second angular difference between two ends of the guiding grooves of the connecting portion passage of each of the return assemblies, and the second angular difference is about half of the first angular difference. The direction where the guiding grooves of the connection portion passage twist is opposite to the direction where the guiding grooves of the linking portion passage. Due to the twisting of the connecting portions of the two return assemblies, before arriving at the return portion passage of the other return assembly, the linking portions of the rolling assembly has been guided to bend in the bendable direction to avoid the improper deformation. After passing the return portion passage, the linking portions of the rolling assembly will twist an angle of about 90 degrees within the sequent linking portion passage and then enter the guiding space smoothly.

As compared to the conventional technology, the present invention has the following advantages:

1. Avoiding improper bending failure: when the rolling assembly is rolling within the circulation path defined by the screw, the nut and the two return assemblies, the rolling assembly will twist the angle of the first angular difference within the linking portion passage of the return passage of one of the return assemblies through the guiding of the guiding grooves, and then the rolling assembly will bend in the bendable direction to smoothly pass through the return portion passage, thus avoiding the serious deformation to avoid improper bending failure.

2. Reducing interference and improper collision: since the guiding grooves of the return portion passage is provided to make the rolling assembly avoid passing the arc routes defined by the smallest and biggest radius of the return portion passage, the linking portions of the rolling assembly can bend in the bendable direction, therefore, the linking portions at the two sides of the rolling assembly will share the load evenly to be synchronously stretched and extruded, thus avoiding the improper deformation of the overall rolling assembly, and the rolling elements will be kept rolling along the optimal path, thus avoiding the improper collision and interference with the return passage and the return elements to reduce the integral damage and the noise to the lowest.

3. Continuous guiding to form a complete recirculation: besides the above guiding design, the rolling assembly further utilizes the first angular difference design and the second angular difference design to twist within the two return assemblies to make the linking portions to bend in the bendable direction to avoid bending excessively within the serious deformation zone, thus forming a complete recirculation path to reduce the interference to the lowest for making the rolling assembly roll within the return passage more smoothly.

### BRIEF DESCRIPTION OF THE DRAWINGS

FIG. 1 is a perspective view of a ball screw in accordance with the present invention;

FIG. 2 is an exploded view of the ball screw in accordance with the present invention;

FIG. 3 is a front view illustrating how the screw cooperates with the return assemblies to allow for passage of the rolling assembly in accordance with the present invention;

FIG. 4 is a front view of the return assembly in accordance with the present invention;

FIG. 5 is a side view of the return assembly in accordance with the present invention;

FIG. 6 is an exploded view of the two return elements of the return assembly in accordance with the present invention;

FIG. 7 is a perspective view illustrating how the screw cooperates with the first return elements of the two return assemblies in accordance with the present invention;

FIG. 8 is a perspective view illustrating how the rolling assembly twists along the return passage in accordance with the present invention; and

FIG. 9 is a plane view of a circulation path of a conventional ball screw.

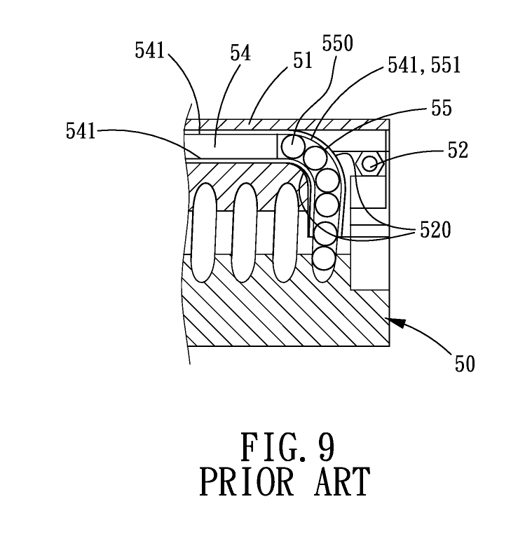

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

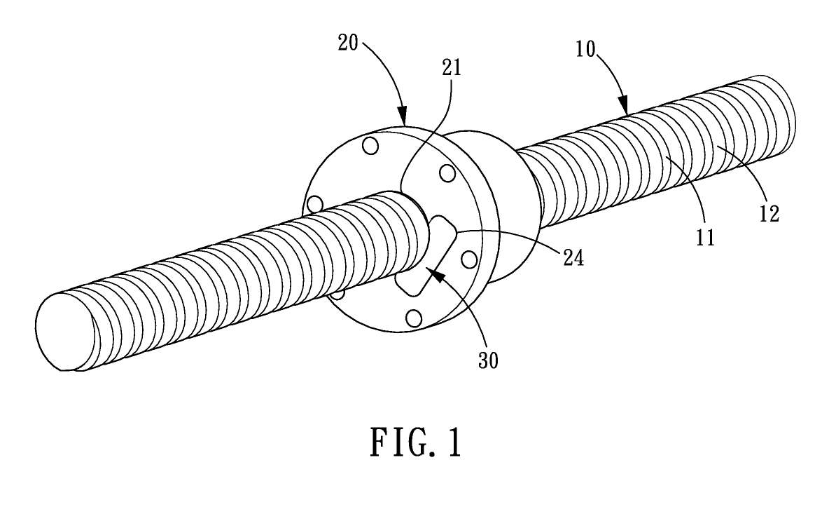

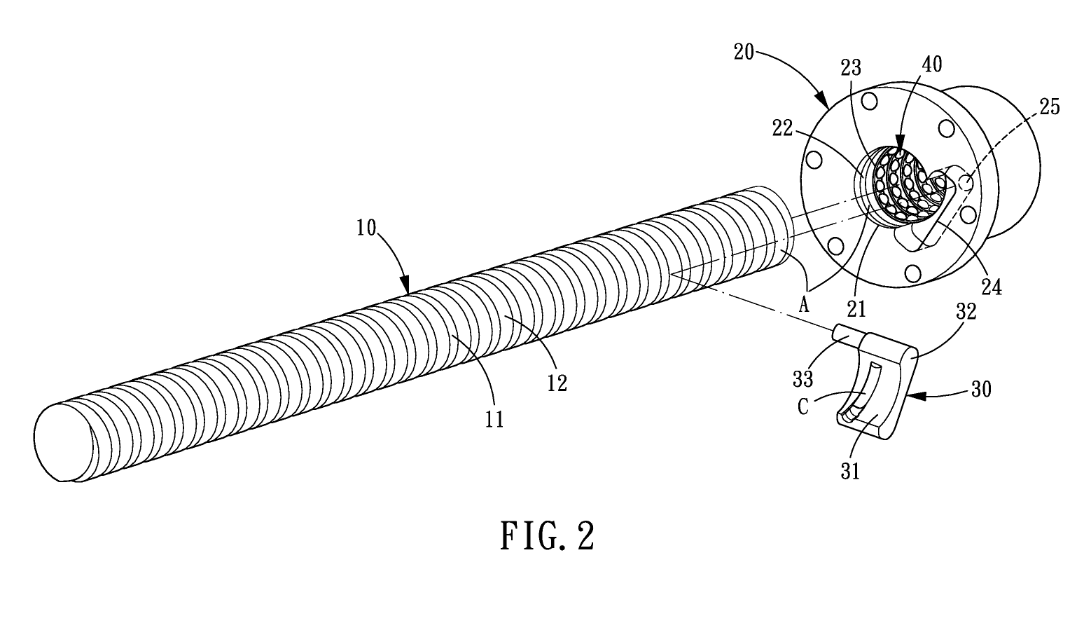

Referring to FIGS. 1-3, a ball screw in accordance with the present invention comprises a screw 10, a nut 20, two return assemblies 30 and a rolling assembly 40.

The screw 10 is provided with a screw helical rolling groove 11 in an outer circumferential surface thereof and a screw thread 12 defined by the screw helical groove 11.

The nut 20 is provided with an insertion hole 21 for insertion of the screw 10, and the insertion hole 21 is provided with a nut helical rolling groove 22 in its inner circumferential surface opposite the screw helical rolling groove 11, and a nut thread 23 defined by the nut helical rolling groove 22. The screw rolling groove 11 and the nut rolling groove 22 cooperate with each to define a loaded path A, and a guiding space B is defined between the screw thread 12 and the nut thread 23. The nut 20 is provided with a receiving groove 24 in each of two opposite ends thereof and a rolling passage 25 between the two receiving grooves 24. The receiving grooves 24 are connected to the loaded path A, respectively.

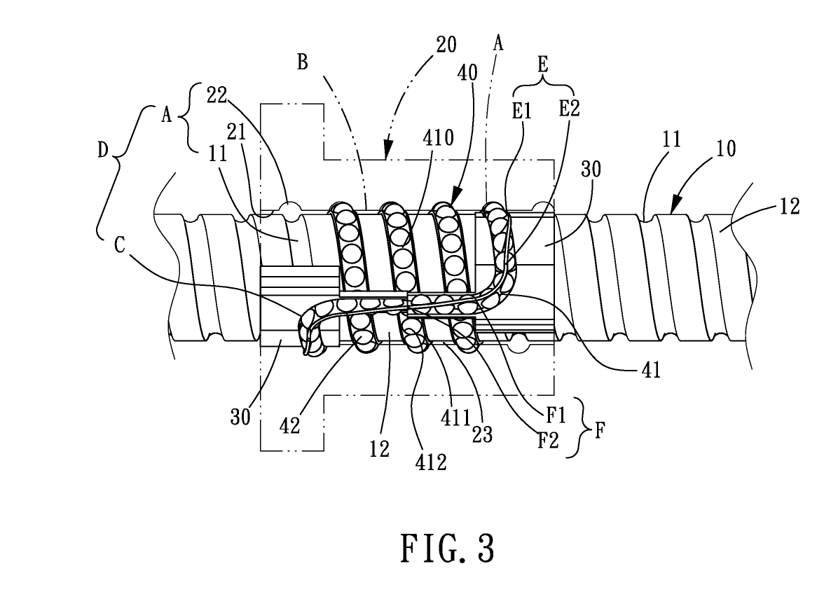

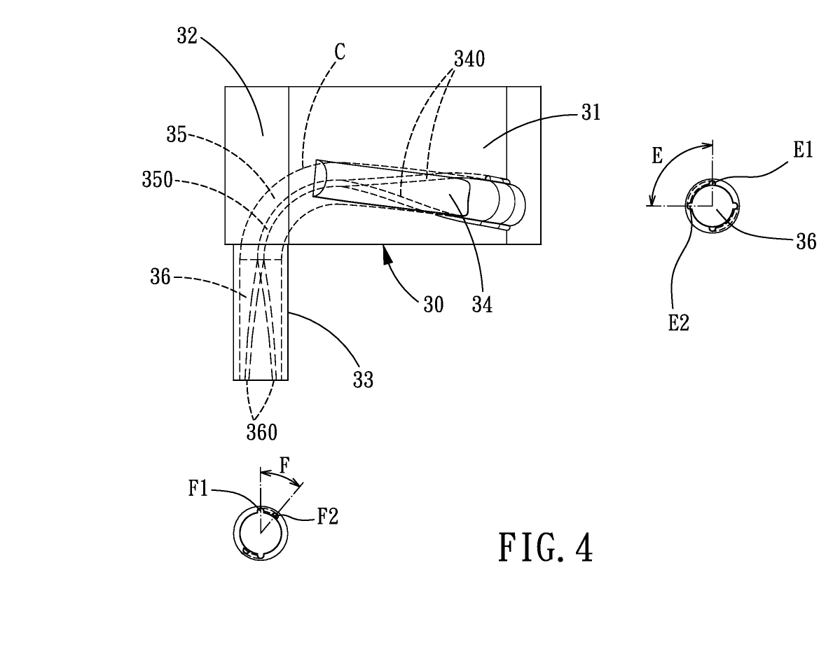

The two return assemblies 30 are disposed in the receiving grooves 24, respectively. As shown in FIGS. 3-4, each of the return assemblies 30 is provided with a linking portion 31, a return portion 32 and a connecting portion 33 in order. Each of the return assemblies 30 is further defined with a linking portion passage 34, a return portion passage 35 and a connecting portion passage 36 in the linking portion 31, the return portion 32 and the connecting portion 33, respectively. One end of the linking portion passage 34 is linked up with the loaded path A, and both ends of the return portion passage 35 are connected to the other end of the linking portion passage 34 and one end of the connecting portion passage 36, thus defining a return passage C. The other end of the connecting portion passage 36 is connected to the rolling passage 25. Each of the linking portion passage 34, the return portion passage 35 and the connecting portion passage 36 is defined with two guiding grooves 340, 350, 360 in the return passage C. One end of the two guiding grooves 340 of the linking portion passage 34 is linked up with the guiding space B, and then the two guiding grooves 340 will twist an angle, and finally, the other end of the two guiding grooves 340 of the linking portion passage 34 will be linked up to one end of the guiding grooves 350 of the return portion passage 35. The other end of the guiding grooves 350 of the return portion passage 35 is linked up with the guiding grooves 360 of the connecting portion passage 36. The guiding grooves 360 of the connecting portion passage 36 will twist an angle relative to the guiding grooves 350 of the return portion passage 35. The return passage C is linked up with the loaded path A to form a complete circulation path D.

The rolling assembly 40 includes a chain 41 and plural rolling elements 42. As shown in FIG. 3, the chain 41 includes plural spacers 410 and two linking portions 411 that are linked together. Each pair of neighboring spacers 410 defines an accommodation space 412 for a rolling element 42. The linking portions 411 are slidably disposed in the guiding space B and the guiding grooves 340, 350 and 360.

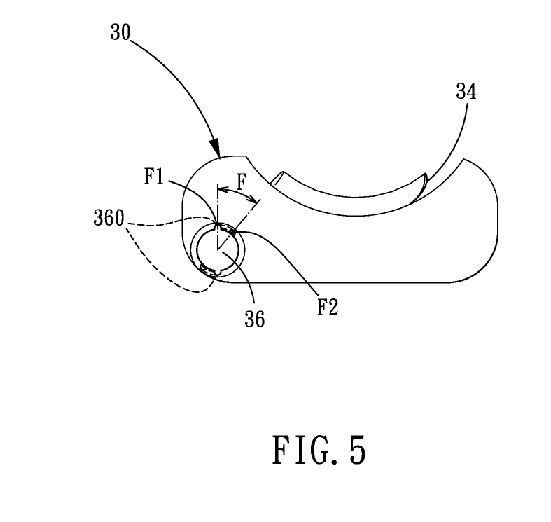

Referring to FIGS. 3-5, the end of the guiding grooves 340 of the linking portion passage 34 of the return passage C, which is connected with the guiding space B, is denoted by the first point E1, and the end, which is connected with the return portion passage 35, is denoted by the second point E2. There is a first angular difference between the first point E1 and the second point E2 with respect to the center point of the linking portion passage 34, and the first angular difference ranges from 80 to 100 degrees, preferably 90 degrees.

In the guiding grooves 360 of the connecting portion passage 36 of the return passage C, the end of the guiding grooves 360, which is connected with the return portion passage 35, is denoted by the first point F1, and the other end of the guiding grooves 360, which is linked up with the other return assembly 30, is denoted by the second point F2. When the two points are projected on the cross section of the connecting portion passage 36, there is a second angular difference between the first point F1 and the second point F2 with respect to the center of the connecting portion passage 36, and the angular difference F ranges from 30 to 60 degrees, preferably 45 degrees.

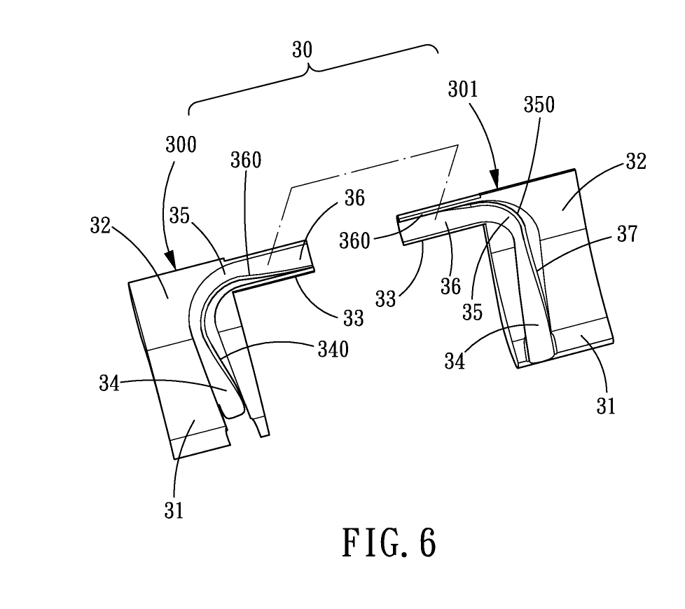

Each of the return assemblies 30 includes a first return element 300 and a second return element 301 that are oppositely combined together, as shown in FIG. 6.

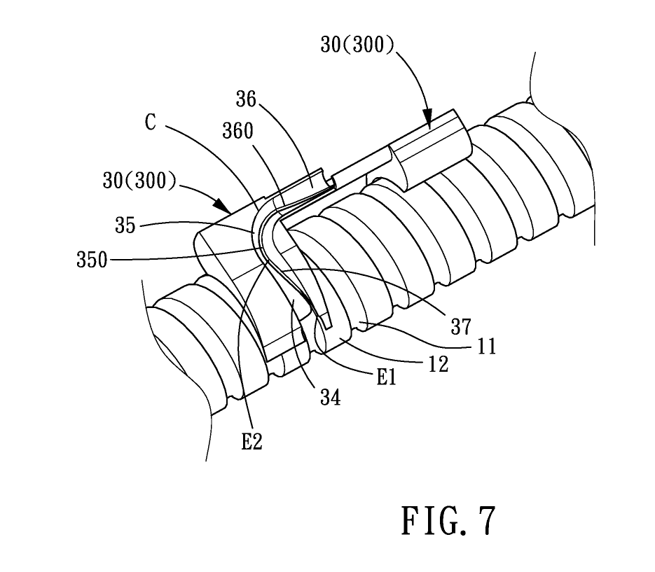

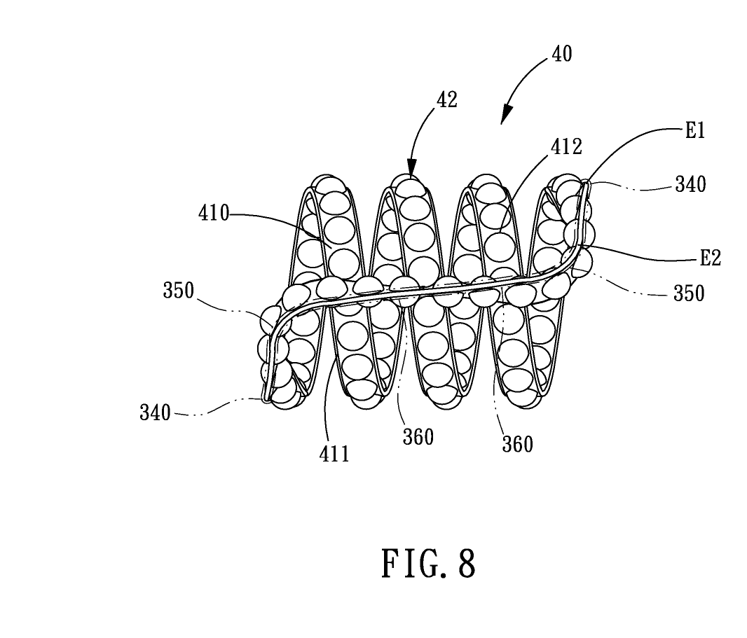

Referring to FIGS. 7-8, when the rolling assembly 40 moves within the linking portion passage 34, the linking portions 411 will be guided to move by the guiding grooves 340 from the first point E1 to the second point E2 of the linking portion passage 34, thus twisting an angle of about 90 degrees that is the first angular difference. After passing through the return portion passage 35 to the connecting portion passage 36, the rolling assembly 40 will move from the first point F1 to the second point F2 of the guiding grooves 360 of the connecting portion passage 36 and thus twist an angle of about 45 degrees that is the second angular difference. By such arrangements, a smooth recirculation is provided.

When the screw 10 rotates, the rolling assembly 40 will be synchronously driven to roll within the circulation path D, thus driving the nut 20 to linearly move on the screw 10. Further, when the rolling assembly 40 rolls to the distal end of the loaded path A, namely entering one of the return assemblies 30, the rolling assembly 40 will enter one end of the return passage C of the one of the return assemblies 30 and then roll out of the other of the return assemblies 30 to return to the start end of the loaded path A to complete the circulation within the circulation path D. The rolling assembly 40 is moved along the loaded path A, the linking portions will move along the guiding space B to cooperate with the rotation of the screw 10. When rolling at the one of the return assemblies 30, the rolling assembly 40 will enter the guiding grooves 340, 350, 360, and twist the angle of the first angular difference E within the linking portion passage 34 to the optimal bending direction, and then the rolling assembly 40 will smoothly pass through the return portion passage 35 to the connecting portion passage 36. After that, the rolling assembly 40 will twist the angle of the second angular difference F within the connecting portion passage 36 and then enter the other of the return assemblies 30. Subsequently, the rolling assembly 40 will also twist the angle of the second angular difference F within the connecting portion passage 36 of the other of the return assemblies 30 and then pass through the return portion passage 35 to the linking portion passage 34, and finally the rolling assembly 40 will also twist the angle of the first angular difference E within the linking portion passage 34 and then return to the loaded path, thus completing a circulation.

Based on a further analysis of the structure of the preferred embodiment of the present invention, it can be found that the present invention has the following advantages:

1. Avoiding improper bending failure: when the rolling assembly 40 is rolling within the circulation path defined by the screw 10, the nut 20 and the two return assemblies 30, the rolling assembly 40 will twist the angle of the first angular difference E within the linking portion passage 34 of the return passage C of one of the return assemblies 30 through the guiding of the guiding grooves 340, and then the rolling assembly 40 will bend in the bendable direction to smoothly pass through the return portion passage 35, thus avoiding the serious deformation to avoid improper bending failure.

2. Reducing interference and improper collision: since the guiding grooves 350 of the return portion passage 35 is provided to make the rolling assembly 40 avoid passing the arc routes defined by the smallest and biggest radius of the return portion passage 35, the linking portions 411 of the rolling assembly 40 can bend in the bendable direction, therefore, the linking portions 411 at the two sides of the rolling assembly 40 will share the load evenly to be synchronously stretched and extruded, thus avoiding the improper deformation of the overall rolling assembly 40, and the rolling elements 42 will be kept rolling along the optimal path, thus avoiding the improper collision and interference with the return passage C and the return elements to reduce the integral damage and the noise to the lowest.

3. Continuous guiding to form a complete recirculation: besides the above guiding design, the rolling assembly 40 further utilizes the first angular difference E design and the second angular difference F design to twist within the two return assemblies 30 to make the linking portions 411 to bend in the bendable direction to avoid bending excessively within the serious deformation zone, thus forming a complete recirculation path to reduce the interference to the lowest for making the rolling assembly 40 roll within the return passage C more smoothly.

While we have shown and described various embodiments in accordance with the present invention, it is clear to those skilled in the art that further embodiments may be made without departing from the scope of the present invention.

What is claimed is:

1. A ball screw comprising:
a screw being provided with a screw helical rolling groove in a circumferential surface thereof and a screw thread being defined by the screw helical rolling groove.
a nut being defined with an insertion hole for insertion of the screw, the insertion hole being provided with a nut helical rolling groove in its inner circumferential surface opposite the screw helical rolling groove, and a nut thread defined by the nut helical rolling groove, a guiding space being defined between the screw thread and the nut thread, the screw rolling groove and the nut rolling groove cooperating with each other to define a loaded path, the nut being provided with a receiving groove in each of two opposite ends thereof and a rolling passage between the two receiving grooves, the receiving grooves being linked to the loaded path, respectively;
two return assemblies being respectively disposed in the receiving grooves, each of the return assemblies being provided with a linking portion, a return portion and a connecting portion in order and further defined with a linking portion passage, a return portion passage and a connecting portion passage in the linking portion, the return portion and the connecting portion, respectively, wherein the linking portion passage is linked up with the loaded path, and both ends of the return portion passage are connected to the linking portion passage and the connecting portion passage, thus defining a return passage, the other end of the connecting portion passage is connected to the rolling passage, each of the linking portion passage, the return portion passage and the connecting portion passage is defined with two guiding grooves in the return passage, one end of the two guiding grooves of the linking portion passage is linked up with the guiding space and has a first angular difference of 90 degrees with respect to the other end of the two guiding grooves of the linking portion passage; and
a rolling assembly including a chain and plural rolling elements, the chain including plural spacers and two linking portions that are linked together, each pair of neighboring spacers defining an accommodation space for a rolling element, the linking portions of the chain being slidably disposed within the guiding space between the screw and the nut and the guiding grooves of the return passage, when the rolling assembly moves from the guiding space to the return portion passage, the linking portions of the chain will be guided by the guiding grooves of the linking portion passage to move and twist an angle of the first angular difference.

2. The ball screw as claimed in claim 1, wherein the first angular difference is an angle defined by a first point and a second point that are projected on a cross section of the linking portion passage with respect to a central point of the linking portion passage, the first point is at a position where the guiding grooves of the linking portion passage are connected with the guiding space and the second point is at a position where the guiding grooves of the linking portion passage are connected with the return portion passage, and the first angular difference ranges from 80 to 100 degrees.

3. The ball screw as claimed in claim 2, wherein the first angular difference is 90 degrees.

4. The ball screw as claimed in claim 1, wherein there is a second angular difference between two ends of the guiding grooves of the linking portion passage of each of the return assemblies.

5. The ball screw as claimed in claim 4, wherein the second angular difference ranges from 30 to 60 degrees.

6. The ball screw as claimed in claim 5, wherein the second angular difference is 45 degrees.
